(19) United States
(12) Patent Application Publication
(10) Pub. No.: US 2007/0228956 A1
(43) Pub. Date: Oct. 4, 2007

(54) PHOSPHOR PASTE COMPOSITION, PLASMA DISPLAY PANEL USING THE SAME, AND MANUFACTURING METHOD THEREOF

(75) Inventors: Bum Jin BAE, Yongin-si (KR); Eun A MOON, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/685,817

(22) Filed: Mar. 14, 2007

(30) Foreign Application Priority Data
Mar. 14, 2006 (KR) 10-2006-0023697
Mar. 14, 2006 (KR) 10-2006-0023699
Mar. 14, 2006 (KR) 10-2006-0023701

(51) Int. Cl. H01J 17/49; H01J 1/62

(52) U.S. Cl. 313/582; 313/586; 313/486

(57) ABSTRACT

A phosphor paste composition, a manufacturing method thereof, a plasma display panel using the same, and a manufacturing method thereof, which are capable of achieving an improvement in bright room contrast and realizing a highly definite display, are disclosed.

This application claims the benefit of Korean Patent Application No. 10-2006-0023701, filed on Mar. 14, 2006, which is hereby incorporated by reference as if fully set forth herein. Also, this application claims the benefit of Korean Patent Application No. 10-2006-0023699, filed on Mar. 14, 2006, which is hereby incorporated by reference as if fully set forth herein. Also, this application claims the benefit of Korean Patent Application No. 10-2006-0023697, filed on Mar. 14, 2006, which is hereby incorporated by reference as if fully set forth herein.

### BACKGROUND OF THE INVENTION

1. Field of the Invention

The present invention relates to a phosphor paste composition, a manufacturing method thereof, a plasma display panel using the same, and a manufacturing method thereof.

2. Discussion of the Related Art

Generally, plasma display panels are known as a display device in which ultraviolet rays generated in accordance with gas discharge excite phosphors to generate visible rays.

In such a plasma display panel, a phosphor performs a very important function of emitting visible light of red, green, or blue as it is excited by ultraviolet rays generated during the plasma discharge.

Generally, the phosphor is made of a phosphor material having the form of a paste. The phosphor paste has a composition including phosphor powder, a binder for providing a certain viscosity to the phosphor power, and a solvent.

Such a phosphor paste is printed between the adjacent barrier ribs, and is then dried. Thereafter, the phosphor paste is subjected to a baking process. However, the phosphor completely formed after the baking process is colored white on the surface thereof.

Due to such a white phosphor, the conventional plasma display panel exhibits high reflectance for external light, and thus exhibits degraded contrast characteristics.

Generally, bright room contrast is referred to as an index for the manufacture of a bright and definite plasma display panel.

The importance of bright room contrast has increased in that bright room contrast has been used as a picture quality evaluation item for plasma display panels. In order to achieve an improvement in bright room contrast, a method in which an appropriate pigment is added to the phosphor paste, taking into the color of the phosphor paste, to reduce the reflectance for external light, has recently been proposed.

However, although a reduction in reflectance is achieved when the pigment is added to the phosphor paste in accordance with the above-mentioned method, there is a problem in realizing a bright and definite display due to a reduction in white brightness.

### SUMMARY OF THE INVENTION

Accordingly, the present invention is directed to a phosphor paste composition, a manufacturing method thereof, a plasma display panel using the same, and a manufacturing method thereof that substantially obviate one or more problems due to limitations and disadvantages of the related art.

An object of the present invention is to provide a phosphor paste composition, a manufacturing method thereof, a plasma display panel using the same, and a manufacturing method thereof capable of achieving an improvement in bright room contrast.

Another object of the present invention is to provide a phosphor paste composition, a manufacturing method thereof, a plasma display panel using the same, and a manufacturing method thereof capable of realizing a high definition display.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a phosphor paste composition comprises: phosphor powder exhibiting a color; an organic or inorganic black pigment to absorb external light, and a vehicle.

In another aspect of the present invention, a plasma display panel comprises: first and second substrates arranged in parallel while being spaced apart from each other by a certain distance; a plurality of electrodes formed on facing surfaces of the first and second substrates; a plurality of barrier ribs defining first, second, and third cells as discharge spaces between the first and second substrates; and a phosphor layer formed in at least one of the first, second, and third cells, the phosphor layer containing an organic or inorganic black pigment to absorb external light.

In another aspect of the present invention, a plasma display panel comprises: first and second substrates arranged in parallel while being spaced apart from each other by a certain distance; a plurality of electrodes formed on facing surfaces of the first and second substrates; a plurality of barrier ribs defining discharge spaces between the first and second substrates; and a phosphor layer formed in each of the discharge spaces, the phosphor layer containing an organic or inorganic pigment exhibiting black to reduce a reflectance for incident light.

In another aspect of the present invention, a method for manufacturing a plasma display panel comprises: preparing a first substrate having first electrodes and a second substrate having second electrodes and a plurality of barrier ribs defining cells as discharge spaces; printing a phosphor paste containing an organic or inorganic black pigment absorbing external light in the cells; drying and baking the printed phosphor paste, thereby forming phosphor layers; and assembling the first and second substrate.

In another aspect of the present invention, a method for manufacturing a plasma display panel comprises: preparing a first substrate having first electrodes and a second substrate having second electrodes and a plurality of barrier ribs defining first, second, and third cells as discharge spaces; printing a first phosphor paste containing an organic or inorganic pigment exhibiting red in the first cell, printing a second phosphor paste containing no pigment in the second cell, and printing a third phosphor paste containing an organic or inorganic pigment exhibiting blue in the third cell; drying and baking the printed phosphor pastes, thereby forming first, second, and third phosphor layers; and assembling the first and second substrate.

In still another aspect of the present invention, a method for manufacturing a plasma display panel comprises: preparing a first substrate having first electrodes and a second substrate having second electrodes and barrier ribs defining discharge spaces; printing a phosphor paste containing an organic or inorganic pigment exhibiting black in the discharge spaces; drying and baking the printed phosphor paste, thereby forming phosphor layers; and assembling the first and second substrate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 and 2 are schematic flow charts illustrating methods for manufacturing phosphor paste compositions in accordance with exemplary embodiments of the present invention, respectively;

FIGS. 3A to 4C are graphs for comparison of the reflectance of phosphors according to exemplary embodiments of the present invention with the reflectance of conventional phosphors; and

FIG. 5 is a sectional view illustrating a plasma display panel manufactured using a phosphor paste composition according to an exemplary embodiment of the present invention.

### DETAILED DESCRIPTION OF THE INVENTION

The present invention now will be described more fully hereinafter with reference to the accompanying drawings, in which preferred embodiments of the invention are shown.

This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention provides a phosphor paste composition which may comprise phosphor powder exhibiting a color, an organic or inorganic black pigment absorbing external light, and a vehicle. The phosphor paste composition can absorb external light (vacuum ultraviolet (VUV) rays), thereby achieving a reduction in reflectance and an increase in white brightness. Hereinafter, this will be described in detail with reference to the following embodiments.

In accordance with an exemplary embodiment of the present invention, the phosphor paste composition may comprise phosphor powder exhibiting a color, an organic or inorganic pigment of the same wavelength band as the color of the phosphor powder, and a vehicle. The vehicle may comprise a lead-free glass frit, an acrylic binder, a buta-acrylic solvent, a deflocculating agent (low molecular weight), or a solvent.

The phosphor paste composition may comprise 80 to 99.99 wt % of phosphor powder, and 0.01 to 20 wt % of a pigment, based on the total amount of the composition exclusive of the vehicle.

The phosphor paste composition may comprise 50 to 99.99 wt % of phosphor powder, 0.01 to 35% of a pigment, and 0 to 15 wt % of a binder, or may comprise 20 to 60 wt % of phosphor powder, 0.01 to 10% of a pigment, 0 to 15 wt % of a binder, 30 to 80 wt % of a solvent, and 0 to 5 wt % of a deflocculating agent.

The pigment may comprise at least one of an organic or inorganic pigment exhibiting a high reflectance in a red wavelength band and an organic or inorganic pigment exhibiting a high reflectance in a blue wavelength band.

For example, the pigment may comprise at least one of an iron oxide pigment, a cobalt green pigment, an emerald green pigment, a chromium oxide green pigment, a chromium-alumina green pigment, a Victoria green pigment, a cobalt blue pigment, a Prussian pigment, a Turkey blue pigment, and a Co—Zn—Si pigment. The pigment may further comprise at least one of α-Fe₂O₃, (Co, Zn).(Al, Cr)₂O₃, 3CaO—Cr₂O₃.3SiO₂, (Al, Cr)₂O₃, CoOAl₂O₃ and 2(Co, Zn)O.SiO₂, and ZrSiO₄.

The phosphor paste composition according to the above-described embodiment of the present invention may comprise the pigment only when the phosphor paste composition is a red phosphor paste composition or a blue phosphor paste composition, and may not comprise the pigment when the phosphor paste composition is a green phosphor paste composition.

This is because it is necessary to minimize brightness loss. This will be described in detail with reference to the following embodiments.

In accordance with an exemplary embodiment of the present invention, the phosphor paste composition may comprise phosphor powder comprising at least one of first, second, and third phosphor powder respectively exhibiting red, green, and blue, a pigment comprising a first organic or inorganic pigment contained in the first phosphor powder and having a high reflectance, a second organic or inorganic pigment contained in the second phosphor powder and having a high reflectance, and a third organic or inorganic pigment contained in the third phosphor powder and having a high reflectance, and a vehicle. The vehicle may comprise a lead-free glass frit, an acrylic binder, a buta-acrylic solvent, a deflocculating agent (low molecular weight), or a solvent.

The first pigment may comprise an iron oxide pigment. The second pigment may comprise at least one of a cobalt green pigment, an emerald green pigment, a chromium oxide green pigment, a chromium-alumina green pigment, and a Victoria green pigment. The third pigment may comprise a cobalt blue pigment, a Prussian pigment, a Turkey blue pigment, and a Co—Zn—Si pigment.

In accordance with an exemplary embodiment of the present invention, the phosphor paste composition may comprise phosphor powder exhibiting a color, an organic or inorganic pigment for achieving a reduction in reflectance for incident light, and a vehicle. The vehicle may comprise a lead-free glass frit, an acrylic binder, a buta-acrylic solvent, a deflocculating agent (low molecular weight), or a solvent.

In this case, the pigment exhibits black corresponding to a light reflectance of 18% or less. The pigment comprises at least one of a cobalt-based pigment, a copper-based pigment, carbon black, and a carbon nano tube (CNT).

The phosphor paste composition may comprise 75 to 99.99 wt % of phosphor powder, 0.01 to 20% of a pigment, and 0 to 15 wt % of a binder, or may comprise 20 to 60 wt % of phosphor powder, 0.01 to 5% of a pigment, 0 to 15 wt % of a binder, 30 to 80 wt % of a solvent, and 0 to 5 wt % of a deflocculating agent.

FIG. 1 is a schematic flow chart illustrating a method for manufacturing a phosphor paste composition in accordance with an exemplary embodiment of the present invention. The phosphor paste composition manufacturing method includes a first process S101 for mixing phosphor powder and an organic or inorganic pigment exhibiting black, and a second process S102 for mixing a vehicle with the mixture of the phosphor powder and pigment.

In the first process S101, 80 to 99.99 wt % of the phosphor powder and 0.01 to 20% of the pigment are mixed. In the second process S102, a binder, a solvent, and a deflocculating agent, as the vehicle, are mixed with the mixture of the phosphor powder and pigment, to manufacture a phosphor paste having a composition comprising 20 to 60 wt % of the phosphor powder, 0.01 to 5% of the pigment, 0 to 15 wt % of the binder, 30 to 80 wt % of the solvent, and 0 to 5 wt % of the deflocculating agent.

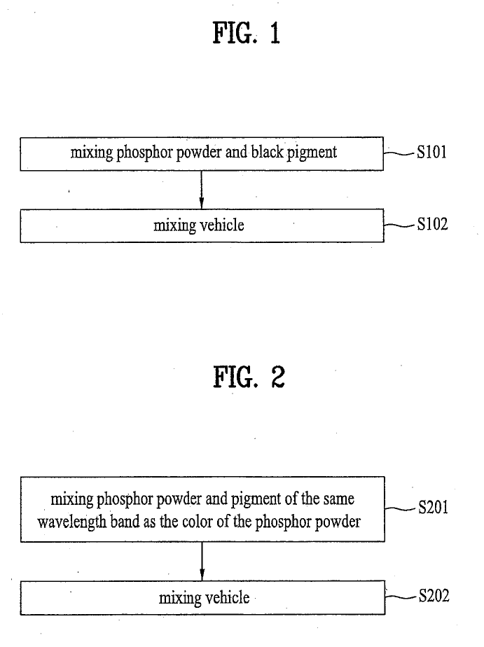

FIG. 2 is a schematic flow chart illustrating a method for manufacturing a phosphor paste composition in accordance with an exemplary embodiment of the present invention. The phosphor paste composition manufacturing method includes a first process S201 for mixing phosphor powder exhibiting a color and an organic or inorganic pigment of the same wavelength band as the color of the phosphor powder, and a second process S202 for mixing a vehicle with the mixture of the phosphor powder and pigment.

In the first process S201, 65 to 99.99 wt % of the phosphor powder and 0.01 to 35% of the pigment are mixed. In the second process S202, a binder, a solvent, and a deflocculating agent, as the vehicle, are mixed with the mixture of the phosphor powder and pigment, to manufacture a phosphor paste having a composition comprising 20 to 60 wt % of the phosphor powder, 0.01 to 10% of the pigment, 0 to 15 wt % of the binder, 30 to 80 wt % of the solvent, and 0 to 5 wt % of the deflocculating agent.

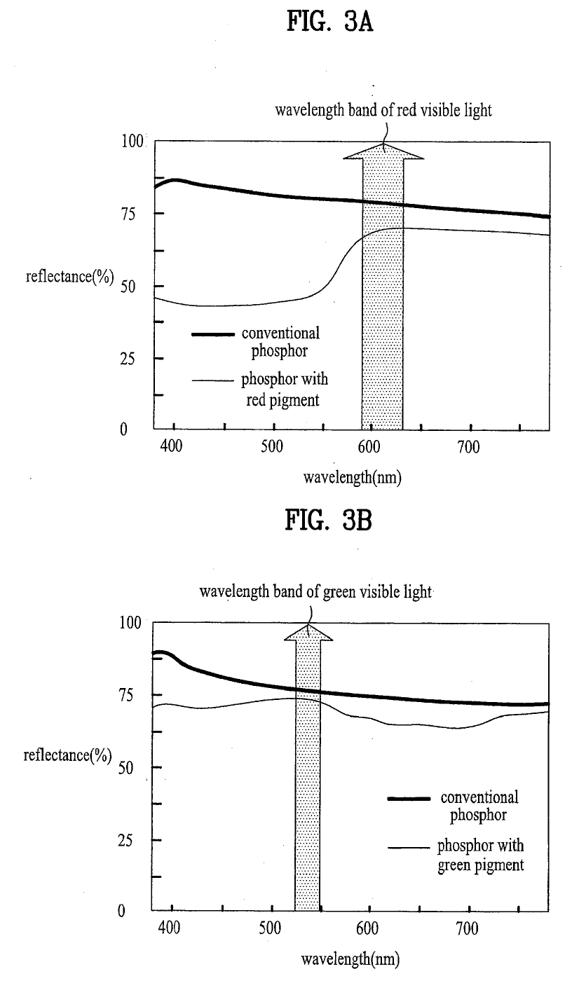

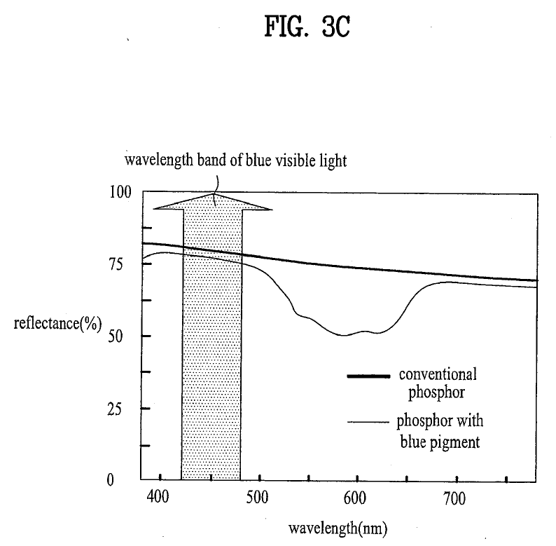

FIGS. 3A to 3C are graphs for comparison of the reflectance of phosphors according to an exemplary embodiment of the present invention with the reflectance of conventional phosphors.

FIG. 3A is a graph for comparison of the reflectance of a red phosphor containing a red pigment with the reflectance of a conventional phosphor. The red phosphor containing the red pigment exhibits a high reflectance in a wavelength band of about 550 to 650 nm while exhibiting a relatively low reflectance in other wavelength bands.

Accordingly, the red phosphor has advantages in that it can achieve an improvement in bright room contrast by virtue of a low reflectance at wavelength bands other than a red wavelength band, and can achieve an increase in red purity by virtue of a high reflectance at the red wavelength band.

As shown in FIG. 3C, a blue phosphor containing a blue pigment exhibits a high reflectance in a wavelength band of about 400 to 500 nm while exhibiting a relatively low reflectance in other wavelength bands.

Accordingly, the blue phosphor has advantages in that it can achieve an improvement in bright room contrast by virtue of a low reflectance at wavelength bands other than a blue wavelength band, and can achieve an increase in blue purity by virtue of a high reflectance at the blue wavelength band.

As shown in FIG. 3B, a green phosphor containing a green pigment exhibits a high reflectance in a wavelength band of about 500 to 600 nm while exhibiting a relatively low reflectance in other wavelength bands. In the green phosphor, however, the difference between the reflectance in the green wavelength band and the reflectance in other wavelength bands is not considerable.

For this reason, the bright room contrast improvement of the green phosphor layer is not considerable, as compared to the other phosphor layers.

Furthermore, the phosphors respectively containing red, green, and blue pigments may exhibit a brightness loss even though they improve the total bright room contrast of the panel.

Therefore, the present invention has features of achieving an improvement in the bright room contrast of the panel by adding pigments only to the red phosphor paste composition and blue phosphor paste composition, and minimizing brightness loss by adding no pigment to the green phosphor paste composition.

That is, in a phosphor paste composition according to an exemplary embodiment of the present invention, which is used to manufacture a plasma display panel, pigments are added only to red and blue phosphor paste compositions, in order to achieve an improvement in bright room contrast and to minimize brightness loss.

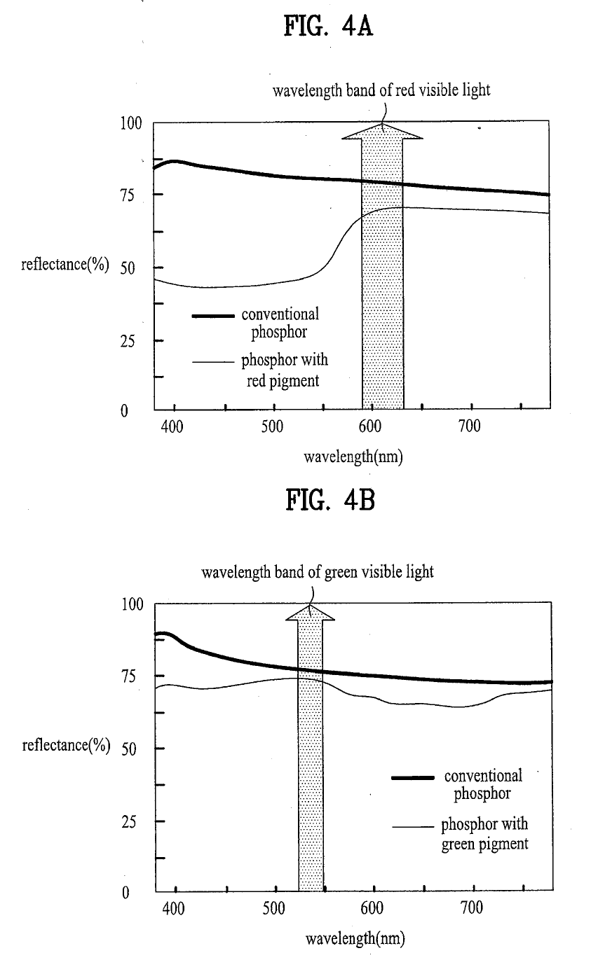

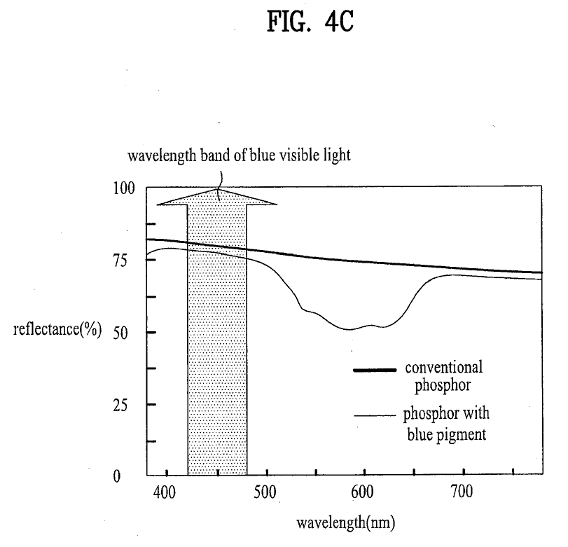

FIGS. 4A to 4C are graphs for comparison of the reflectance of phosphors according to an exemplary embodiment of the present invention with the reflectance of conventional phosphors.

Referring to FIGS. 4A to 4C, it can be seen that each phosphor used in the present invention exhibits a high reflectance in the associated wavelength band while exhibiting a relatively low reflectance in other wavelength bands.

For example, the red phosphor containing the red pigment exhibits a high reflectance in the red wavelength band while exhibiting a relatively low reflectance in other wavelength bands. Accordingly, the red phosphor has advantages in that it can achieve an improvement in bright room contrast, an enhancement in red purity, and an improvement in color coordinate.

This is because the pigment itself functions as a color filter.

The green phosphor containing the green pigment and the blue phosphor containing the blue pigment can obtain the same effects as those of the red phosphor.

As described with reference to the above embodiments and depicted in the above graphs, the phosphor paste composition according to the present invention absorbs external light (vacuum ultraviolet (VUV) rays), thereby reducing the reflectance for the external light and increasing white brightness. Thus, the reflectance for the external light can be reduced to 50 to 60%.

The plasma display panel, which is manufactured using the above-described phosphor paste composition, comprises first and second substrates arranged in parallel while being spaced apart from each other by a certain distance, a plurality of electrodes formed on facing surfaces of the first and second substrates, a plurality of barrier ribs defining first, second, and third cells as discharge spaces between the first and second substrates, and a phosphor layer formed in at least one of the first, second, and third cells. The phosphor layer contains an organic or inorganic pigment absorbing external light.

In accordance with the present invention, a method for manufacturing the plasma display panel using the phosphor paste composition is also provided. The method comprises preparing a first substrate having first electrodes and a second substrate having second electrodes and a plurality of barrier ribs defining cells as discharge spaces, printing a phosphor paste containing an organic or inorganic pigment adsorbing external light in the cells, drying and baking the printed phosphor paste, thereby forming phosphor layers, and assembling the first and second substrate.

Hereinafter, the plasma display panel and manufacturing method thereof will be described in detail with reference to the following embodiments.

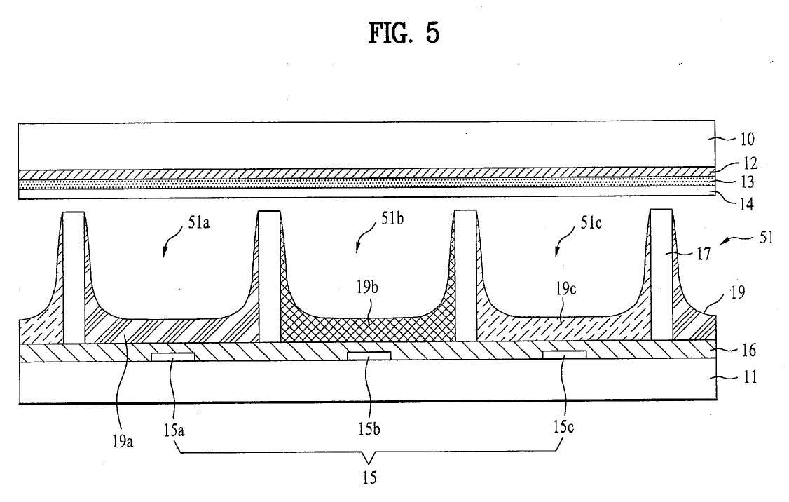

FIG. 5 is a sectional view illustrating a plasma display panel manufactured using a phosphor paste composition according to an exemplary embodiment of the present invention.

First, a first substrate 10 and a second substrate 11 are prepared, as shown in FIG. 5.

Here, the first substrate 10 is an upper substrate, and the second substrate 11 is a lower substrate.

A plurality of sustaining electrodes 12 are then formed on the first substrate 10. An upper dielectric layer 13 is formed on the sustaining electrodes 12.

A passivation film 14 containing MgO is formed over the upper dielectric layer 13.

Meanwhile, on the second substrate 11 facing the first substrate 10, a plurality of address electrodes 15 (15a, 15b, and 15c) are formed such that they are arranged orthogonal to the sustaining electrodes 12 of the first substrate 10. A lower dielectric layer 16 is formed on the address electrodes 15.

A plurality of barrier ribs 17 are formed to have a certain height on the lower dielectric layer 16, in order to define cells 51 as discharge spaces, namely a first cell 51a, a second cell 51b, and a third cell 51c.

Phosphor layers 19 (19a, 19b, and 19c) emitting red light, green light, and blue light are formed in the first, second, and third cells 51a, 51b, and 51c, respectively. Accordingly, the first, second, and third cells 51a, 51b, and 51c function as red, green, and blue discharge cells, respectively. Each phosphor layer 19 contains an organic or inorganic pigment (R, G, or B) exhibiting a color with the same wavelength band as the light emitted from the phosphor layer 19, to obtain a high light emission rate in the wavelength band of the light emitted from the phosphor layer 19.

The formation of the phosphor layers 19 (19a, 19b, and 19c) is carried out as follows. First, a red phosphor paste containing an organic or inorganic pigment exhibiting red to have a high reflectance in the red wavelength band is printed in the first cell 51a.

The printing of the red phosphor paste may be achieved using a screen printing method, a dispensing method or an ink jet method.

The red pigment has a high reflectance in a wavelength band of about 550 to 650 nm while having a relatively low reflectance in other wavelength bands. For the red pigment, an iron oxide pigment such as α-Fe₂O₃ may be used.

The red phosphor paste has a composition comprising 20 to 60 wt % of phosphor powder, 0.01 to 10% of a pigment, 0 to 15 wt % of a binder, 30 to 80 wt % of a solvent, and 0 to 5 wt % of a deflocculating agent.

Thereafter, a green phosphor paste containing no pigment is printed in the second cell 51b.

The green phosphor paste has a composition comprising 30 to 60 wt % of phosphor powder, 0 to 15 wt % of a binder, 30 to 80 wt % of a solvent, and 0 to 5 wt % of a deflocculating agent.

Subsequently, a blue phosphor paste containing an organic or inorganic pigment exhibiting blue to have a high reflectance in the blue wavelength band is printed in the third cell 51c.

The blue pigment has a high reflectance in a wavelength band of about 400 to 500 nm while having a relatively low reflectance in other wavelength bands. For the blue pigment, a cobalt blue pigment, a Prussian pigment, a Turkey blue pigment, or a Co—Zn—Si pigment such as CoOAl₂O₃ and 2(Co, Zn).SiO₂, or ZrSiO₄ may be used.

The blue phosphor paste has a composition comprising 20 to 60 wt % of phosphor powder, 0.01 to 10% of a pigment, 0 to 15 wt % of a binder, 30 to 80 wt % of a solvent, and 0 to 5 wt % of a deflocculating agent.

The red, green, and blue phosphor pastes are dried and baked to form red, green, and blue phosphor layers 19a, 19b, and 19c.

The baking temperature of the phosphor pastes is adjusted to be about 400 to 600° C. Each of the red and blue phosphor layers 19a and 19c may have a composition comprising 65 to 99.99 wt % of phosphor powder and 0.01 to 35 wt % of a pigment.

The phosphor layers 19 (19a, 19b, and 19c) may be formed using another method, as follows. First, a first phosphor paste containing an organic or inorganic pigment exhibiting red to have a high reflectance in the red wavelength band is printed in the first cell 51a.

The printing of the first phosphor paste may be achieved using a screen printing method, a dispensing method or an ink jet method.

The pigment contained in the first phosphor paste has a high reflectance in a wavelength band of about 550 to 650 nm while having a relatively low reflectance in other wavelength bands. For the red pigment, an iron oxide pigment such as α-Fe₂O₃ may be used.

The first phosphor paste has a composition comprising 20 to 60 wt % of phosphor powder, 0.01 to 10% of a pigment, 0 to 15 wt % of a binder, 30 to 80 wt % of a solvent, and 0 to 5 wt % of a deflocculating agent.

Thereafter, a second phosphor paste containing an organic or inorganic pigment exhibiting green to have a high reflectance in the green wavelength band is printed in the second cell 51b.

The pigment contained in the second phosphor paste has a high reflectance in a wavelength band of about 500 to 600 nm while having a relatively low reflectance in other wavelength bands. For the green pigment, a cobalt green pigment, an emerald green pigment, a chromium oxide green pigment, a chromium-alumina green pigment, or a Victoria green pigment such as (Co, Zn)O.(Al, Cr)₂O₃, 3CaO—Cr₂O₃.3SiO₂, or (Al, Cr)₂O₃ may be used.

The green phosphor paste has a composition comprising 20 to 60 wt % of phosphor powder, 0.01 to 10 wt % of a pigment, 0 to 15 wt % of a binder, 30 to 80 wt % of a solvent, and 0 to 5 wt % of a deflocculating agent.

Subsequently, a third phosphor paste containing an organic or inorganic pigment exhibiting blue to have a high reflectance in the blue wavelength band is printed in the third cell 51c.

The blue pigment has a high reflectance in a wavelength band of about 400 to 500 nm while having a relatively low reflectance in other wavelength bands. For the blue pigment, a cobalt blue pigment, a Prussian pigment, a Turkey blue pigment, or a Co—Zn—Si pigment such as CoOAl₂O₃ and 2(Co, Zn)O SiO₂, or ZrSiO₄ may be used.

The third phosphor paste has a composition comprising 20 to 60 wt % of phosphor powder, 0.01 to 10% of a pigment, 0 to 15 wt % of a binder, 30 to 80 wt % of a solvent, and 0 to 5 wt % of a deflocculating agent.

The first, second, and third phosphor pastes are dried and baked to form first, second, and third phosphor layers 19a, 19b, and 19c.

The baking temperature of the phosphor paste is adjusted to be about 400 to 600° C. Each of the first, second, and third phosphor layers 19a, 19b, and 19c may have a composition comprising 65 to 99.99 wt % of phosphor powder and 0.01 to 35 wt % of a pigment.

The phosphor layers 19 (19a, 19b, and 19c) may be formed using another method, as follows. First, a phosphor paste containing an organic or inorganic pigment exhibiting black is printed over the lower dielectric layer 16 and on the side surfaces of each barrier rib 17.

The printing of the phosphor paste may be achieved using a screen printing method, a dispensing method or an ink jet method.

The phosphor paste containing the black pigment may be formed in all cells 51 in the same manner, or may be formed in a part of the cells 51.

The phosphor paste is dried and baked to form phosphor layers 19.

The baking temperature of the phosphor paste is adjusted to be about 400 to 600° C.

The phosphor layers 19 exhibit a dark color corresponding to a light reflectance of 18% or less, and have a composition comprising 80 to 99.99 wt % of phosphor powder and 0.01 to 20 wt % of a pigment.

Thereafter, the first substrate 10 and second substrate 20 are assembled. Thus, the manufacture of the plasma display panel is completed.

As described with reference to the above embodiments and depicted in the above graphs, the plasma display panel of the present invention includes the phosphor layers capable of absorbing external light (vacuum ultraviolet (VUV) rays), thereby reducing the reflectance for the external light and increasing white brightness. Thus, it is possible to reduce the reflectance for the external light to 50 to 60%, and thus to achieve improvements in color purity and bright room contrast. It is also possible to enhance the light emission rate of the phosphor layers 19, and thus to realize a highly definite display.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A phosphor paste composition comprising:
phosphor powder; and
an organic or inorganic black pigment.

2. The phosphor paste composition according to claim 1, wherein the composition comprises 80 to 99.99 wt % of the phosphor powder, and 0.01 to 20 wt % of the pigment.

3. The phosphor paste composition according to claim 1, wherein the composition comprises 50 to 99.99 wt % of the phosphor powder, 0.01 to 35 wt % of the pigment, and 0 to 15 wt % of a binder.

4. The phosphor paste composition according to claim 1, wherein the composition comprises 20 to 60 wt % of the phosphor powder, 0.01 to 10 wt % of the pigment, and 0 to 15 wt % of a binder, 30 to 80 wt % of a solvent, and 0 to 5 wt % of a deflocculating agent.

5. The phosphor paste composition according to claim 1, wherein the composition comprises 75 to 99.99 wt % of the phosphor powder, 0.01 to 20 wt % of the pigment, and 0 to 15 wt % of a binder.

6. The phosphor paste composition according to claim 1, wherein the composition comprises 20 to 60 wt % of the phosphor powder, 0.01 to 5 wt % of the pigment, and 0 to 15 wt % of a binder, 30 to 80 wt % of a solvent, and 0 to 5 wt % of a deflocculating agent.

7. The phosphor paste composition according to claim 1, further comprising:
at least one of α-Fe₂O₃, (Co, Zn)O.(Al, Cr)₂O₃, 3CaO—Cr₂O₃.3SiO₂, (Al, Cr)₂O₃, CoOAl₂O₃ and 2(Co, Zn)O.SiO₂, and ZrSiO₄.

8. The phosphor paste composition according to claim 1, wherein the black pigment has a light reflectance of 18% or less.

9. The phosphor paste composition according to claim 8, wherein the pigment comprises at least one of a cobalt-based pigment, a copper-based pigment, carbon black, and a carbon nano tube (CNT).

10. A plasma display panel comprising:
first and second substrates arranged in parallel while being spaced apart from each other by a certain distance;
a plurality of electrodes formed on facing surfaces of the first and second substrates;
a plurality of barrier ribs defining first, second, and third cells as discharge spaces between the first and second substrates; and
a phosphor layer formed in at least one of the first, second, and third cells, the phosphor layer containing an organic or inorganic black pigment.

11. The plasma display panel according to claim 10, wherein:
the first phosphor layer has a high reflectance in a wavelength band of 550 to 650 nm while having a relatively low reflectance in other wavelength bands;
the second phosphor layer has a high reflectance in a wavelength band of 500 to 600 nm while having a relatively low reflectance in other wavelength bands; and
the third phosphor layer has a high reflectance in a wavelength band of 400 to 500 nm while having a relatively low reflectance in other wavelength bands.

12. A plasma display panel comprising:
first and second substrates arranged in parallel while being spaced apart from each other by a certain distance;
a plurality of electrodes formed on facing surfaces of the first and second substrates;
a plurality of barrier ribs defining first, second, and third cells as discharge spaces between the first and second substrates; and
a red phosphor layer formed in the first cell while containing an organic or inorganic pigment exhibiting red, a green phosphor layer formed in the second discharge cell, the green phosphor layer containing no pigment, and a blue phosphor layer formed in the third discharge cell while containing an organic or inorganic pigment exhibiting blue.

13. A plasma display panel comprising:
first and second substrates arranged in parallel while being spaced apart from each other by a certain distance;
a plurality of electrodes formed on facing surfaces of the first and second substrates;
a plurality of barrier ribs defining discharge spaces between the first and second substrates; and
a phosphor layer formed in each of the discharge spaces, the phosphor layer containing an organic or inorganic black pigment exhibiting black to reduce a reflectance for incident light.

14. A method for manufacturing a plasma display panel, comprising:
preparing a first substrate having first electrodes and a second substrate having second electrodes and a plurality of barrier ribs defining cells as discharge spaces;
printing a phosphor paste containing an organic or inorganic black pigment in the cells;
drying and baking the printed phosphor paste, thereby forming phosphor layers; and
assembling the first and second substrate.

15. The method according to claim 14, wherein the printing of the phosphor paste is carried out using at least one of a screen printing method, a dispensing method, and an ink jet method.

16. The method according to claim 14, wherein the baking of the phosphor paste is carried out at a temperature of 400 to 600° C.

17. The method according to claim 14, wherein the phosphor paste has a composition comprising 20 to 60 wt % of phosphor powder, 0.01 to 10% of the pigment, 0 to 15 wt % of a binder, 30 to 80 wt % of a solvent, and 0 to 5 wt % of a deflocculating agent.

18. A method for manufacturing a plasma display panel, comprising:
preparing a first substrate having first electrodes and a second substrate having second electrodes and a plurality of barrier ribs defining first, second, and third cells as discharge spaces;
printing a first phosphor paste containing an organic or inorganic pigment exhibiting red in the first cell, printing a second phosphor paste containing no pigment in the second cell, and printing a third phosphor paste containing an organic or inorganic pigment exhibiting blue in the third cell;
drying and baking the printed phosphor pastes, thereby forming first, second, and third phosphor layers; and
assembling the first and second substrate.

19. A method for manufacturing a plasma display panel, comprising:
preparing a first substrate having first electrodes and a second substrate having second electrodes and barrier ribs defining discharge spaces;
printing a phosphor paste containing an organic or inorganic pigment exhibiting black in the discharge spaces;
drying and baking the printed phosphor paste, thereby forming phosphor layers; and
assembling the first and second substrate.
